(19) United States
(12) Patent Application Publication
(10) Pub. No.: US 2015/0193802 A1
(43) Pub. Date: Jul. 9, 2015

(54) Online Media Tipping System

(71) Applicant: Terry Stephen Tenison, Lawrenceburg, TN (US)

(72) Inventor: Terry Stephen Tenison, Lawrenceburg, TN (US)

(21) Appl. No.: 14/507,534

(22) Filed: Oct. 6, 2014

Related U.S. Application Data
(60) Provisional application No. 61/924,102, filed on Jan. 6, 2014.

(51) Int. Cl. G06Q 30/02; G06Q 20/24; G06Q 50/00; H04L 29/08; H04L 29/06

(52) U.S. Cl. CPC G06Q 30/0215; H04L 67/10; H04L 65/40; G06Q 50/01; G06Q 20/24

(57) ABSTRACT

A system and method for tipping online media content files through a user interface such as a website includes a plurality of user accounts. A credit bank is included with each of the plurality of user accounts. Furthermore, each of the plurality of user accounts is connected to a plurality of social media accounts which include a plurality of media content files. Each of the plurality of media content files can be tipped through a tipping module available for each of the plurality of user accounts. In the tipping process, credits are transferred from one credit bank to the other. The credits accumulated in the credit bank of each of the plurality of user accounts can be used to receive a cash reward or purchase a physical item. Furthermore, the credits in the credit bank can also be used to purchase an item through an online store.

The current application claims a priority to the U.S. Provisional Patent application Ser. No. 61/924,102 filed on Jan. 6, 2014.

### FIELD OF THE INVENTION

The present invention relates generally to user-based and user driven media content files and systems. More specifically, the present invention is a tipping system which allows media content viewers and visitors to reward the original content owner or creator.

### BACKGROUND OF THE INVENTION

The rapid development and spread of the internet has led to the rise of media content websites. These websites are often centered on user-submitted content such as videos, images, links, and original content that are uploaded to the internet for viewing by others. Media content websites in particular are driven by user participation in both providing new content and creating interaction between users. Website users are typically able to post comments and generate discussions based on viewed content. The rise of social media systems has yielded multiple platforms for even further exposure of popular media content. Media content sites frequently include means for users to quickly post or embed enjoyed content to various social media platforms. In addition to commenting on and discussing uploaded content, websites offer users the ability to “like” submitted content that they particularly enjoy. As such, the most popular or highly rated content is often viewed by a very large audience. It is not uncommon for particularly popular videos to accumulate extremely high viewership numbers. However, while “liking” and rating submitted content increases the exposure of the content, there is generally no way for users to reward or otherwise incentivize other users for posting particularly enjoyable content. The present invention seeks to enhance and improve upon conventional media content websites and systems that are centered on user-based and user-driven submission of media content.

The present invention is a tipping system for online media content that allows users to monetarily reward media content owners or creators. In the preferred embodiment of the present invention, the tipping system comprises a website and a tipping module. Tips are submitted in the currency form of “credits”. The tipping module is installed or embedded on media content and is utilized to directly reward credits to media content owners or creators. In the present invention, the tipping module comprises a web browser extension and associated software. However, the present invention is not limited with respect to this specific application of the tipping module. The tipping module is downloadable from the website and all users (tippers and media content owners or creators) are required to be registered on the website. Once registered, media content owners or creators may download the tipping module for installation or embedding on the desired media content. Once initialized, the tipping module directs tippers to a store hosted by the tipping system website. Tippers are able to purchase credits at a designated rate (i.e. 95 credits purchased for 1 United States dollar). Once credits have been purchased and associated with an account, the account owner may send tips to owners or creators of enjoyable media content. Tips and credits are accumulated by the user accounts of media content owners or creators. In various embodiments and supported applications of the present invention, the credits accumulated from received tips may be redeemed for prizes such as electronics, clothing, and appliances. Additionally, the credits may be exchanged for cash at a designated rate (i.e. 105 credits exchanged for 1 United States dollar). Various additional embodiments and supported applications of the present invention may allow users to participate in contests based on the number of tips or total amount of credits accumulated for popular media content or the number of tips or total amount of credits sent to media content owners or creators. Contests may be run based on timed intervals such as weekly, monthly, etc. The winner of a contest may receive a prize in the form of additional credits, physical items, or cash.

The object of the present invention is to promote internet user participation and interaction by enhancing websites that are centered on user-provided media content. In addition to media content, the tipping module may be integrated with user discussion or comment boards. Because user discussion and commenting on news articles, media content, product pages, forums, and other content is very common, the present invention may be utilized to provide tips in the context of an online discussion. Because of the incentives provided by the tipping system, the present invention encourages Internet users to actively participate in posting, sharing, and voting for quality content.

### BRIEF DESCRIPTION OF THE DRAWINGS

FIG. 1 is a flowchart illustrating the basic overall method of the present invention.

FIG. 2 is a flowchart illustrating the process of obtaining the list of payment information of the present invention.

FIG. 3 is a flowchart illustrating the plurality of user accounts connecting to the plurality of social media accounts in the present invention.

FIG. 4 is a flowchart illustrating the method of displaying the tipping module of the present invention.

FIG. 5 is a flowchart illustrating the method of determining a prize winner from the plurality of selected user accounts of the present invention.

FIG. 6 is a flowchart illustrating the method of purchasing an item or receiving a cash reward from the present invention.

### DETAIL DESCRIPTIONS OF THE INVENTION

All illustrations of the drawings are for the purpose of describing selected versions of the present invention and are not intended to limit the scope of the present invention.

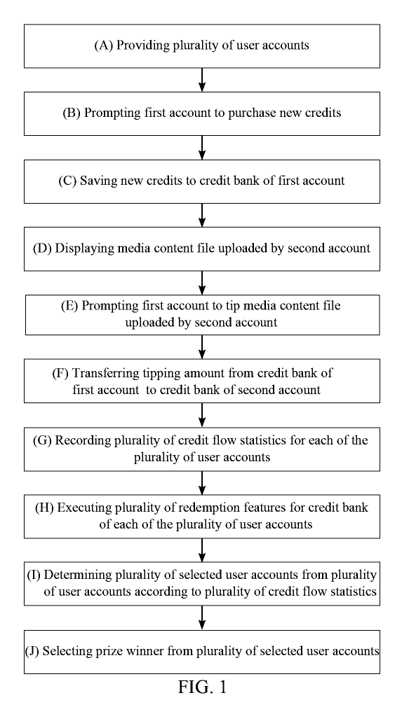

The present invention is a system and method that is used to tip online media content available through social media accounts. The overall process of the present invention is illustrated in FIG. 1. The online media content can be, but is not limited to, pictures, videos, and music. The system includes a website and a server. The website is the user interface of the system. A first user who is registered on the website can tip online media content uploaded by a second user who is also registered on the website. The tip is given as credits, which can later be either exchanged for a gift, or redeemed for a cash reward. As a result of the tipping system, individuals are encouraged to share high quality online media content. The server stores data that can include, but is not limited to, tipping information and payment information.

In order to utilize the present invention, a plurality of user accounts is created on the website. When created, the present invention allows each of the plurality of user accounts to share a plurality of media content files through the website. Furthermore, each of the plurality of user accounts has the ability to tip the plurality of media content files shared by other users through the website. As mentioned before, tipping is done with credits. In order to store the credits used for tipping, each of the plurality of user accounts includes a credit bank which is utilized in the tipping process. For instance, if a first account from the plurality of user accounts tips a second account from the plurality of user accounts, credits from the credit bank of the first account are transferred to the credit bank of the second account in order to complete the tipping process. More specifically, a credit transfer takes place between the first account and the second account.

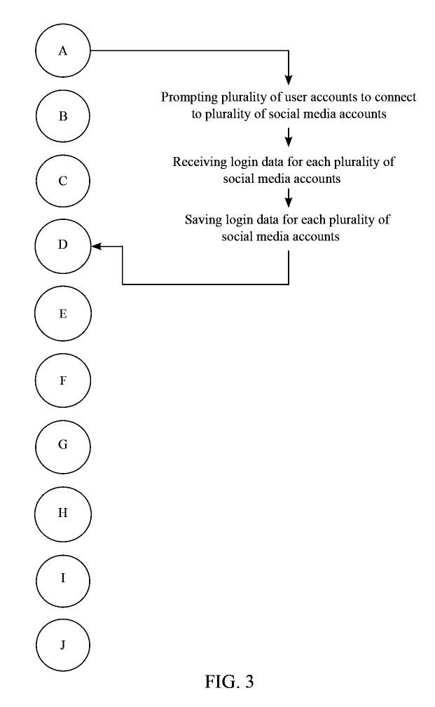

The present invention can be used to tip the plurality of media content files available through a plurality of social media accounts. Each of the plurality of media content files available through the plurality of social media accounts can be, but is not limited to, a picture, video file, or audio file. Additionally, the present invention can also be used to tip other media content available through the plurality of social media accounts which can be, but is not limited to, discussions. This can be beneficial for users who maintain an online blog or participate in online discussions. In order to display each of the plurality of media content files that is available, each of the plurality of user accounts is prompted to connect to each of the plurality of social media accounts as illustrated in FIG. 3. For instance, the first account is prompted to connect to the plurality of social media accounts associated with the user of the first account. Similarly, the second account is prompted to connect to the plurality of social media accounts operated by the second account user. Upon connecting to the plurality of social media accounts, the login data for each of the plurality of social media accounts is received by the server. Afterwards, the received login data for each of the plurality of user accounts is saved on the server for future usage. As a result of each of the plurality of user accounts being connected to the plurality of social media accounts, each of the plurality of media content files displayed through the plurality of social media accounts can be tipped using the present invention.

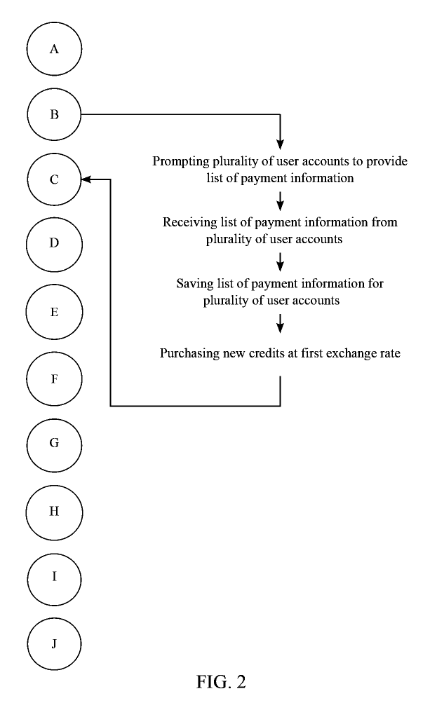

Upon creating the plurality of user accounts, the credit bank of each of the plurality of user accounts initially contains no credits. In order to add credits, the present invention prompts each of the plurality of user accounts to provide a list of payment information in order to purchase new credits. The list of payment information can include information such as, but is not limited to, bank account numbers, credit card numbers, and routing numbers. The server receives the list of payment information for each of the plurality of user accounts and saves the list of payment information for future use. The server then prompts each of the plurality of user accounts to purchase the new credits at a first exchange rate. When the first account is created, the server prompts the first account to purchase new credits. When the first account purchases the new credits, the new credits are added to the credit bank of the first account. The number of credits the first account will receive depends on a first exchange rate. More specifically, the first exchange rate determines the amount of new credits that will be deposited to the credit bank of the first account per unit of money spent. As an example, if the first account pays 1 United States dollar, the present invention will transfer 95 credits or any other comparable amount to the credit bank of the first account. The first exchange rate is also used by the remainder of the plurality of user accounts in order to purchase new credits. The process of receiving the list of payment information and purchasing the new credits is illustrated in FIG. 2.

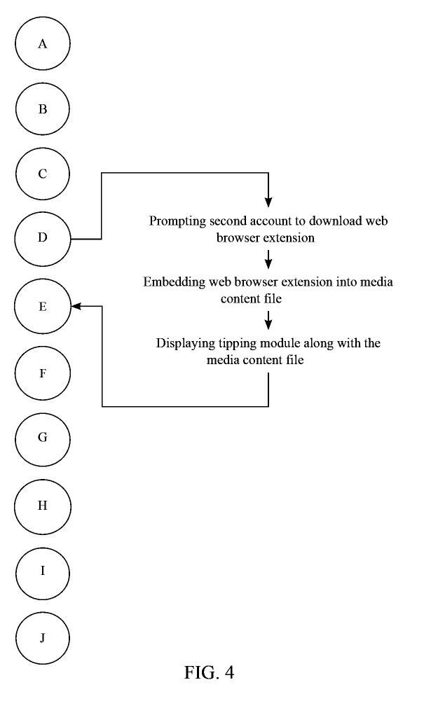

When the plurality of user accounts is registered on the website, each of the plurality of media content files associated with each of the plurality of user accounts has the ability to receive tips. More specifically, the first account can view a media content file associated with the second account, which allows the first account to tip the media content file uploaded by the second account. In the preferred embodiment of the present invention, the first account can tip the second account through a tipping module. The tipping module appears along with each of the plurality of media content files associated with the second account. However, in order to display the tipping module along with each of the plurality of media content files, the second user must first download a web browser extension. When downloaded, the web browser extension embeds the tipping module into each of the plurality of social media accounts associated with the second account. As a result, the tipping module is displayed along with each of the plurality of media content files available through the plurality of social media accounts associated with the second account. FIG. 4 is an illustration of the process of displaying the tipping module with each of the plurality of media content files. Furthermore, the tipping module allows the first account to select a tipping amount. When the first account tips the second account, the tipping amount is transferred from the credit bank of the first account to the credit bank of the second account as credits. As a result, the credits associated with the tipping amount will be reduced from the credit bank of the first account. Simultaneously, the credits associated with the tipping amount will be added to the credit bank of the second account. Once the credit transaction is complete, the present invention records a plurality of credit flow statistics for the first account and the second account. For instance, the plurality of credit flow statistics can include, but is not limited to, information such as the transferred number of credits and the plurality of user accounts involved in the credit transfer. Similarly, the plurality of credit flow statistics is recorded for each credit transaction that takes place through the website for each of the plurality of user accounts. Next, the plurality of credit flow statistics is saved on the server for future usage.

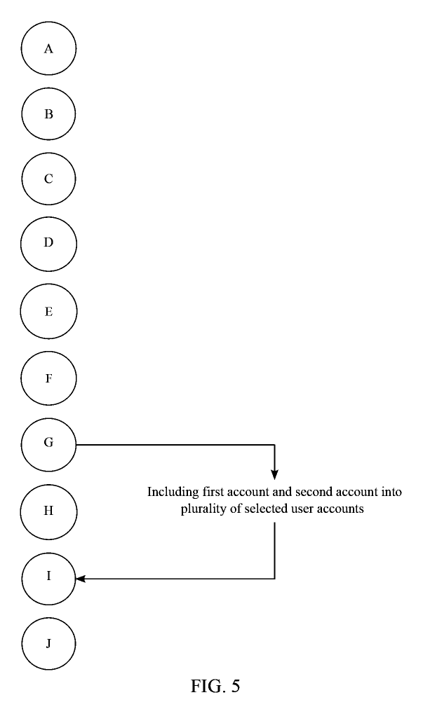

In addition to giving and receiving tips for each of the media content files, each of the plurality of user accounts also has the ability to win prizes or purchase items through a plurality of redemption features of the present invention. One redemption feature includes randomly selecting a prize winner. In order to select the prize winner, the present invention determines a plurality of selected user accounts from the plurality of user accounts using the plurality of credit flow statistics. When the plurality of credit flow statistics between the first account and the second account is recorded and saved, the first account and the second account are added to the plurality of selected user accounts as seen in FIG. 5. Furthermore, the plurality of selected user accounts also includes any other user account of the plurality of user accounts that participated in the tipping process through the present invention. Afterwards, the present invention randomly generates a prize winner from the plurality of selected user accounts. The selecting of the prize winner can be conducted at predetermined intervals. For instance, the prize winner can be chosen weekly, monthly or annually.

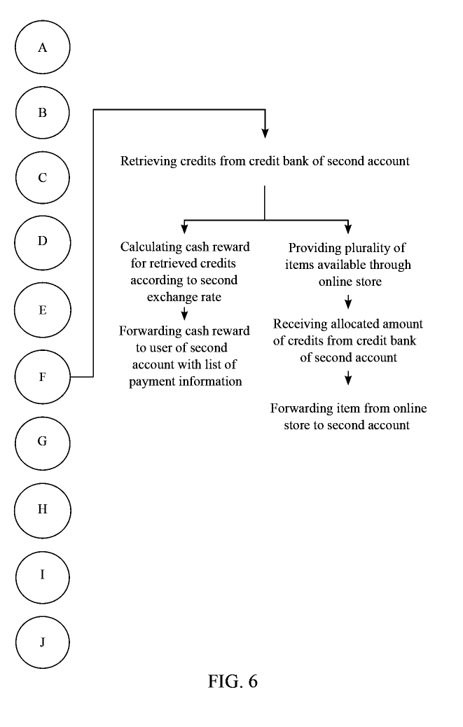

Another redemption feature allows users to exchange credits for a plurality of items as illustrated in FIG. 6. The credit exchange process can be completed through an online store provided as one of the plurality of redemption features. The plurality of items available on the online store is displayed to the plurality of user accounts through the website. Each of the plurality of items is associated with an allocated amount of credits, which is displayed along with the plurality of items. The plurality of items can be purchased using the credit bank of each of the plurality of user accounts. If the second account intends on purchasing a preferred item from the plurality of items, the allocated amount of credits for the preferred item is retrieved from the credit bank of the second account. In return, the preferred item is provided to the user of the second account using the information obtained when creating the second account on the website.

The plurality of redemption features also allows the plurality of user accounts to receive a cash reward for credits available in the credit bank of each of the plurality of user accounts. The second account may choose to receive the cash reward as one of the plurality of redemption features. In doing so, the server prompts the second account to enter a redemption value, and the second account in turn enters the redemption value. When the redemption value is entered, the present invention retrieves a portion of the credit bank of the second account according to the redemption value. In return, the present invention calculates the cash reward for the second account according to the portion of the credit bank of the second account and a second exchange rate. For instance, the present invention can retrieve 105 credits in return for 1 United States dollar as the cash reward. Next, the cash reward is forwarded to the second account by utilizing the list of payment information provided by the second account.

The present invention also allows the plurality of user accounts to share the plurality of items available through the online store via the plurality of social media accounts. As a result, viewers of the plurality of social media accounts can view the plurality of items available through the online store. Since the plurality of items available through the online store is categorically organized, a viewer can conveniently browse through the plurality of items. The plurality of items available through the online store can be, but is not limited to, electronics, clothing, and appliances.

Although the invention has been explained in relation to its preferred embodiment, it is to be understood that many other possible modifications and variations can be made without departing from the spirit and scope of the invention as hereinafter claimed.

What is claimed is:

1. A method for tipping shared media content on an electronic communication device by executing computer-executable instructions stored on a non-transitory computer-readable medium, the method comprises the steps of:
providing a plurality of user accounts, wherein each of the plurality of user accounts includes a credit bank;
prompting a first account to purchase new credits, wherein the first account is one of the plurality of user accounts;
adding the new credits to the credit bank for the first account;
displaying a media content file associated with a second account, wherein the second account is another one of the plurality of user accounts;
prompting the first account to select a tipping amount for the media content file through a tipping module;
transferring the tipping amount from the credit bank of the first account to the credit bank of the second account;
recording a plurality of credit flow statistics for the credit bank of each of the plurality of user accounts;
executing a plurality of redemption features for the credit bank of each of the plurality of user accounts;
determining a plurality of selected user accounts from the plurality of user accounts using the plurality of credit flow statistics; and
randomly generating a prize winner from the plurality of selected user accounts.

2. The method for tipping shared media content on an electronic communication device by executing computer-executable instructions stored on a non-transitory computer-readable medium, the method as claimed in claim 1 further comprises the steps of:
prompting each of the plurality of user accounts to provide a list of payment information;
receiving the list of payment information for each of the plurality of user accounts;
saving the list of payment information for each of the plurality of user accounts; and
prompting each of the plurality of user accounts to purchase the new credits at a first exchange rate.

3. The method for tipping shared media content on an electronic communication device by executing computer-executable instructions stored on a non-transitory computer-readable medium, the method as claimed in claim 1 further comprises the steps of:
prompting each of the plurality of user accounts to connect to a plurality of social media accounts;
receiving login data for each of the social media accounts for each of the user accounts; and
saving the login data for each of the user accounts.

4. The method for tipping shared media content on an electronic communication device by executing computer-executable instructions stored on a non-transitory computer-readable medium, the method as claimed in claim 3 further comprises the steps of:
prompting each of the plurality of user accounts to download a web browser extension;
embedding the web browser extension into each of the social media accounts for a plurality of media content files; and
displaying the tipping module along with the plurality of media content files.

5. The method for tipping shared media content on an electronic communication device by executing computer-executable instructions stored on a non-transitory computer-readable medium, the method as claimed in claim 1 further comprises the steps of:
recording the credit flow statistics between the first account and the second account;
saving the credit flow statistics for both the first account and the second account; and
adding the first account and the second account into the plurality of selected user accounts.

6. The method for tipping shared media content on an electronic communication device by executing computer-executable instructions stored on a non-transitory computer-readable medium, the method as claimed in claim 1 further comprises the steps of:
providing an online store as one of the plurality of redemption features; and
displaying a plurality of items available through the online store to the plurality of user accounts, wherein each of the plurality of items is associated with an allocated amount of credits.

7. The method for tipping shared media content on an electronic communication device by executing computer-executable instructions stored on a non-transitory computer-readable medium, the method as claimed in claim 6 further comprises the steps of:
prompting the second account to select a preferred item from the plurality of items; and
retrieving the allocated amount of credits for the preferred item from the credit bank of the second account.

8. The method for tipping shared media content on an electronic communication device by executing computer-executable instructions stored on a non-transitory computer-readable medium, the method as claimed in claim 1 further comprises the steps of:
providing a cash reward as one of the plurality of redemption features;
prompting the second account the enter a redemption value;
retrieving a portion of the credit bank of the second account according to the redemption value; and
calculating the cash reward from the portion of the credit bank of the second account and a second exchange rate.

9. The method for tipping shared media content on an electronic communication device by executing computer-executable instructions stored on a non-transitory computer-readable medium, the method as claimed in claim 1, wherein the plurality of user accounts can share a plurality of items available through an online store via a plurality of social media accounts.

10. The method for tipping shared media content on an electronic communication device by executing computer-executable instructions stored on a non-transitory computer-readable medium, the method as claimed in claim 6, wherein the plurality of items available through the online store are categorically organized.
